(19) United States
(12) Patent Application Publication
(10) Pub. No.: US 2024/0226965 A1
(43) Pub. Date: Jul. 11, 2024

(54) WIPING PROCESSES IN ROBOTIC PAINT REPAIR

(71) Applicant: 3M INNOVATIVE PROPERTIES COMPANY, St. Paul, MN (US)

(72) Inventors: Aaron K. Nienaber, Lake Elmo, MN (US); Nathan J. Herbst, Woodbury, MN (US); Jonathan B. Arthur, Hudson, WI (US); Dirk Mueller, Mettmann (DE); Joseph B. Eckel, Vadnais Heights, MN (US); Udo W. Scheuvens, Heinsberg (DE); Rufus C. Sanders, Burnsville, MN (US); Alireza Ghaderi, Woodbury, MN (US); Mark W. Orlando, Chesterfield Township, MI (US)

(21) Appl. No.: 18/559,602

(22) PCT Filed: May 11, 2022
(86) PCT No.: PCT/US2022/028683

§ 371 Date: Nov. 8, 2023

Related U.S. Application Data
(60) Provisional application No. 63/201,752, filed on May 11, 2021.

(51) Int. Cl. B08B 1/14; B08B 1/36

(52) U.S. Cl. CPC B08B 1/143; B08B 1/36

(57) ABSTRACT

A wiping system for a robotic repair unit is presented that includes a motive robot arm with a motor, a connection mechanism coupled to the motive robot arm, and a wiping medium coupled to the connection mechanism. The wiping medium includes a base layer and a plurality of features extending from the base layer. The motive robot arm, powered by the motor, moves the wiping medium. The motive robot arm is configured to move the wiping medium toward, or away from, a worksurface. The motive arm is configured to press the wiping medium toward the worksurface during a wiping operation. During the wiping operation, the wiping medium is driven by a wiping motor against the surface.

### BACKGROUND

The automotive industry often needs to prepare surfaces of vehicle parts or replacement parts (e.g., a bumper) for various purposes (e.g., painting), or to repair surfaces of car parts or replacement parts due to defects incurred during painting or coating. Typical surface preparation processes include, for example, physically abrading car surfaces, or “scuffing”. Typical repair operations often include, for example, sanding and polishing. Surface preparation and repair of defects on surfaces can utilize different tools. materials and fluids.

### SUMMARY

A wiping system for a robotic repair unit is presented that includes a motive robot arm with a motor, a connection mechanism coupled to the motive robot arm, and a wiping medium coupled to the connection mechanism. The wiping medium includes a base layer and a plurality of features extending from the base layer. The motive robot arm, powered by the motor, moves the wiping medium. The motive robot arm is configured to move the wiping medium toward, or away from, a worksurface. The motive arm is configured to press the wiping medium toward the worksurface during a wiping operation. During the wiping operation, the wiping medium is driven by a wiping motor against the surface.

The removal of process fluid or slurry during the defect repair process has been shown to benefit the final workpiece product and may be accomplished by adding a fluid removal step subsequent to any abrasion processing. It has been shown that the limiting factor in wipe efficiency is water removal. Wiping parameters should be selected to drive water out of the pad such that the pad operates close to a steady state, with respect to water retention, for as long as possible while still removing a high percentage of slurry from the repair. This removal step has previously required the use of human operators manually wiping the workpiece surface to remove process fluid. By including the first, second, and fluid removal tools all on a single motive robot arm, and potentially with a single force control unit, the process of effectively repairing an automotive surface is streamlined.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic of a robotic paint repair system in which embodiments of the present invention are useful.

FIG. 2 is a schematic of a paint repair robot in which embodiments of the present invention are useful.

FIG. 3 is a schematic of a dual-mounted end effector system of a paint repair robot in accordance with embodiments herein.

FIGS. 4A and 4B are image results of a haze quality experiment.

FIGS. 5A-5B illustrates a dual-mounted end-effector system with fluid removal tool in accordance with embodiments herein.

FIG. 6 illustrates possible placement of a fluid removal tool on a dual mounted end effector system.

FIG. 7 illustrates one embodiment of a fluid removal tool.

FIG. 8 illustrates a schematic of a robotic repair system in accordance with embodiments herein.

FIG. 9 illustrates a method of conducting defect repair operation in accordance with embodiments herein.

FIGS. 10A-10C illustrate wiping mediums in accordance with embodiments herein.

FIGS. 11A and 11B illustrate wiping systems in accordance with embodiments herein.

FIGS. 12A-12D illustrate vacuum attachments for fluid removal systems in accordance with embodiments herein.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides an automated system and methods of using robotic repair unit with an end-of-arm system with mounted tools for processing (e.g., scuffing, sanding, polishing, etc.) an object surface, and a fluid, slurry or debris removal tool which may be utilized before, after and/or between such process steps. The processing tools along with the fluid removal tool can be mounted on an end effector at the end of a motive robot arm, such that they capable of moving between various areas on a workpiece. A process tool may include a functional component configured to contact and prepare the object surface; one or more sensors configured to detect working state information of the end-effector tool, a dispenser for fluid while the functional component contacts and prepares the object surface; and/or a control circuit to receive signals from the sensors and process the signals to generate state information of the tool. The controller may also calculate the area wiped as well, e.g. total number of uses, duration of use, saturation of fluid removal and rest period for drying. The fluid removal tool may also include one or more sensors configured to detect working state information of the tool, a force control unit or an end effector that allows for movement or force application by the fluid removal tool against a worksurface.

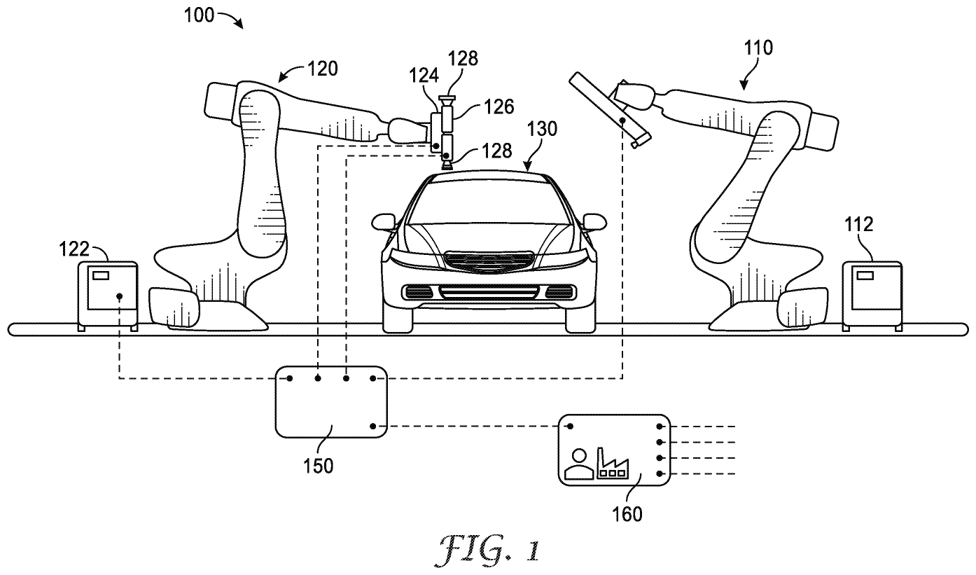

FIG. 1 is a schematic of a robotic paint repair system in which embodiments of the present invention are useful. System 100 generally includes two units, a visual inspection system 110 and a defect repair system 120, which each may include subunits. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, a force control 124 may be coupled to either end effector 126, each of which is coupled to a tool 128. Tools 128 may be arranged, in one embodiment, as further described such as those described in U.S. Provisional Patent Application with Ser. Nos. 62/940,950 and 62/940,960, both filed Nov. 2, 2019. However, other arrangements are also expressly contemplated. Visual inspection unit 110 may detect defects on a vehicle surface 130, which may then be repaired by repair unit 120.

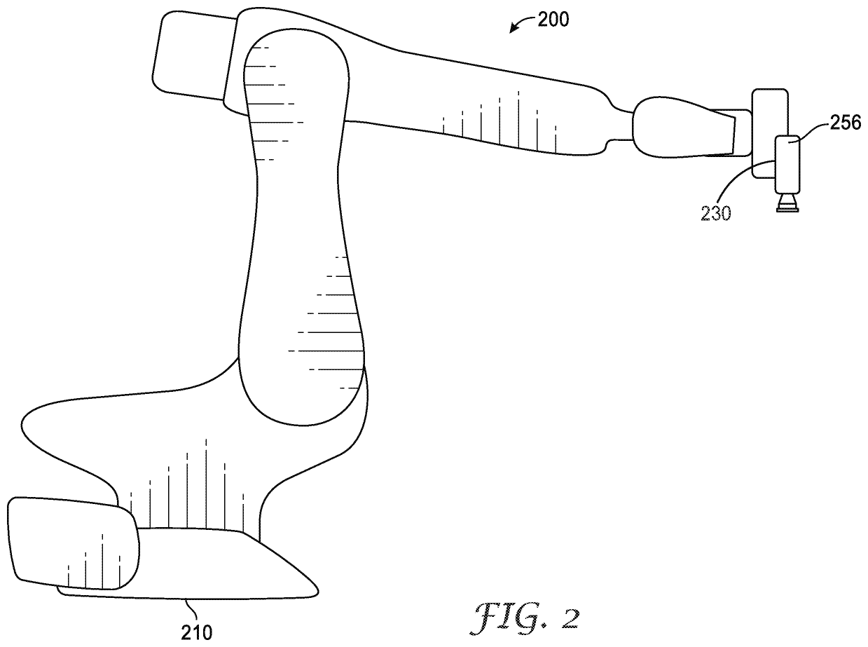

FIG. 2 is a schematic of a paint repair robot which may be useful in embodiments of the present invention. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a vehicle being repaired, or may be mounted on a wall or ceiling carrier. Depending on a defect location, robot 200 may need to move closer, or further away from a vehicle, or may need to move higher or lower with respect to the vehicle. A moveable base 210 may make repairing difficult-to-reach defects easier.

Robotic repair unit 200 has one or more tools 256 that can interact with a worksurface. Tool 256 may include a backup pad, in one embodiment, or another suitable abrasive tool. During an abrasive operation, tool 256 may have an abrasive disc, or other suitable abrasive article, attached using adhesive, hook and loop, clip system, vacuum or other suitable attachment system. As mounted to the robotic repair unit 200, tool 256 has the ability to be positioned within the provided degrees of freedom by the robotic repair unit 200 (6 degrees of freedom in most cases) and any other degrees of freedom (e.g., a compliant force control 230 unit) with its reference frame.

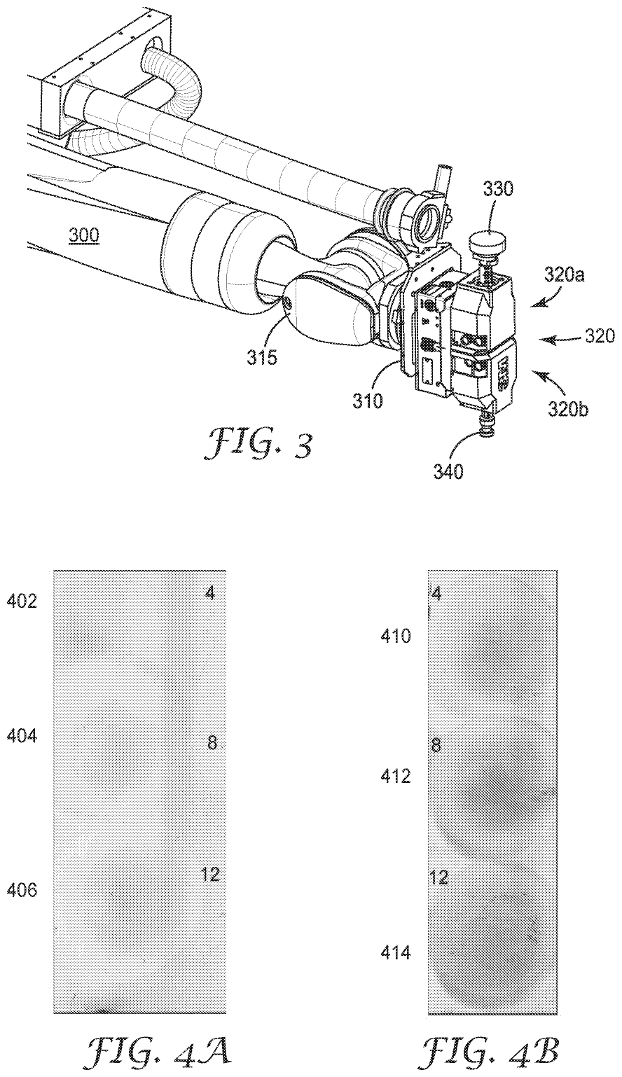

FIG. 3 illustrates an embodiment of dual-mounted end effector systems 320 on a robot arm 300. Robot arm 300 can move end effector system 320 rotationally, using mounting adapter plate 310 and vertically, using joint 315. In some embodiments, robot arm 300 can move such that both a first tool 330 or a second tool 340 can be positioned to interact with a workpiece. System 320, as illustrated, uses a single force control unit, mounted to plate 310, to alternatively operate first and second tools 330, 340. First and second use position have one of tools 330, 340 aligned with force control.

During the paint or clearcoat repair process, fluid may be dispensed on the workpiece prior to, during, or subsequent to the utilization of either of tools 330 or 340. This process fluid may combine with particulate matter from the process to create a fluid slurry. The particulate matter composing this slurry is generally caused by the sanding process, which usually takes place prior to a polish buffing step. Processing by tool 330 or 340, without prior removal of this slurry fluid, may have adverse effects on the final paint surface. Such adverse effects include a hazy or unbuffed appearance or undesired scratches or other damage in the final painted product, which can be caused by micro scratches. The improvement seen when the slurry is removed was unexpected, as it is not a standard for robotic repair systems to remove the slurry prior to surface buffing. The hazy or imperfect appearance is not observable on every buffed surface, but is most noticeable after a buildup of sanding slurry or particulate matter on the buff pad. The adverse effects of buildup on the buff pad were demonstrated by an experiment conducted on a clearcoat workpiece.

FIGS. 4A-4B are image results of a haze quality experiment. The experiment compared fluid removal against non-fluid removal defect repair process methods on a sanded and buffed surface. In completing this experiment, the surface from 4A was sprayed with water, sanded, and buffed with a small bead of polish in 12 consecutive cycles, with slurry fluid removed after each sanding step. The fluid removal was done via hand using a wiping technique. Images of the buffed surface were captured after the 4^{th}, 8^{th}, and 12^{th} sanding/buffing cycles, and are referenced by 402, 404, and 406, respectively. FIG. 4B shows results of a similar 12 cycle sanding and buffing test without the fluid removal after the sanding steps. The results after the 4^{th}, 8^{th}, and 12^{th} sanding/buffing cycles are referenced by 410, 412, and 114, respectively.

As is shown in FIGS. 4A and 4B, removal of fluid between the sanding and buffing steps leads to a reduction in haze in the appearance in the surface of the paint at the end of the repair process. A current practice utilized by some manufacturers is to have human operators manually remove the slurry after sanding and prior to the buffing step. This manual step is completed by wiping the workpiece with an absorbent material such as a towel or sponge to remove slurry or particulate matter which may cause defects in final paint or clearcoat product. As used herein, the term absorbent refers to a material that absorbs fluid when in contact with a solution or suspension. The absorbent material may contain voids or channels that can entrain fluids or may contain fibers designed to wick up moisture. As many solutions used with abrasive materials are water-based, in some embodiments, absorbent refers to a hydrophilic material. An absorbent material may be a nonwoven or woven material.

The current processes of having a human manually wipe the workpiece surface after each sanding step is time consuming. The process time of automated paint buffing could be improved by streamlining or automating the fluid removal process step.

It was thought that the step of wiping could be removed entirely as robotic systems took over the defect repair process. Since human operators generally complete a wiping step so that they can see the repair area for a subsequent polish step, it was thought that the wiping step could be removed, as the robot does not need to “see” the defect area in order to continue to a polishing step. However, as seen in the comparison between FIGS. 4A and 4B illustrates a clear improvement in the finish, over multiple defect repairs, of the robotic repair process when the wiping step is reintroduced.

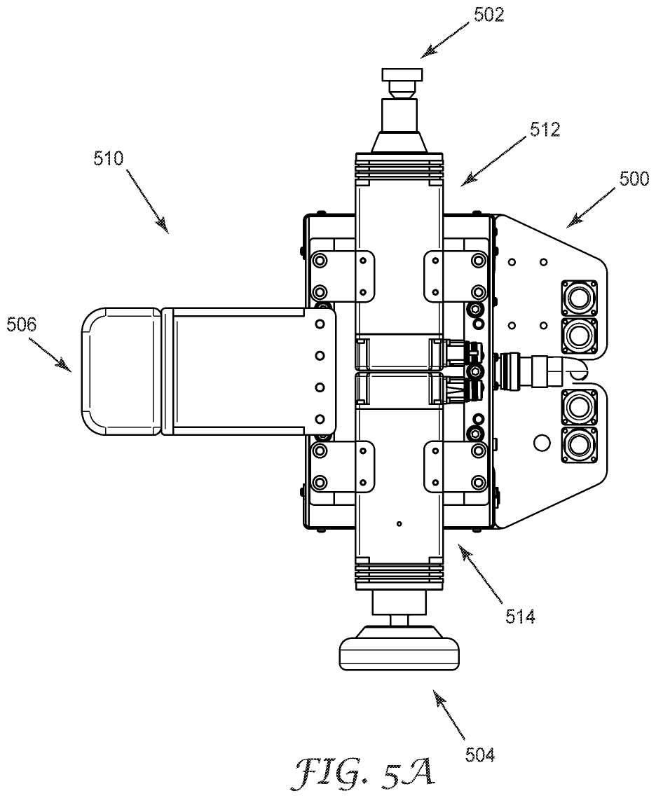

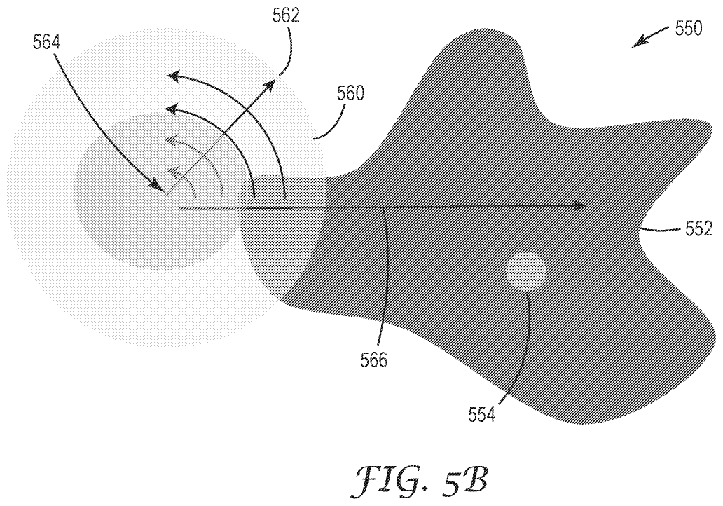

FIG. 5A illustrates a sanding tool system 500 with dual mounted tools 502 and 504. In one embodiment, system 500 is mountable to an end-of-arm of a robotic repair unit. Tools 502 and 504 are coupled to end effectors 512 and 514, respectively. End effectors 512 and 514 are both coupled to a force control unit (not shown in FIG. 5) which is attached to a mounting plate. System 500 is capable of rotating at least 180 degrees to allow for either tool 502 or tool 504 to make contact with the workpiece in a single operation. Each of tools 502 and 504 may be used for polishing, sanding, or other surface preparation purposes. FIG. 5 tool configuration also illustrates a fluid removal tool 506. In one embodiment, fluid removal tool 506 is coupled to sanding tool system 500 using a fastener 508. In the embodiment illustrated in FIG. 5, fluid removal tool 506 is a passive removal tool that is dragged across the surface in contact with the slurry fluid. Fluid removal tool 506 may be a cloth, sponge, or other wiping medium.

However, while FIG. 5A illustrates a passive removal system, in other embodiments fluid removal tool 506 is an active fluid removal tool including a movement system, such as a vacuum or air knife. Similarly, while systems and methods are described herein with respect to a linear, unidirectional wiping process, it is expressly removed that more complex motion, such as that of rotary, orbital or random orbital devices.

In other embodiments, fluid removal tool 506 is a semi-passive removal system, for example with a passive element 506 but an active movement element, for example a fastener 508 that is extendable through a mechanical element. For example, fluid removal tool 506 may incorporate a spring or pneumatic compliance source to allow for compliance upon applied pressure or force. Alternatively, the fluid removal tool can be mounted such that it uses the same compliance tool that the sanding or buffing tool is mounted to.

In some embodiments, fluid removal tool 506 is positioned to be part of a path of rotation of system 500, e.g. such that wiping medium 506 intersects arc 520. Such positioning may allow fluid removal tool 506 to contact the workpiece as system 500 rotates between a first position, where tool 502 interacts with a surface, and a second position, where tool 504 interacts with a surface. Fastener 508 may be a fixed member, or fastener 508 may also be utilized to couple fluid removal tool 506 to a force controller. In some embodiments, Fastener 508 is sized to position fluid removal tool 506 on the arc of rotation 520, allowing removal tool 506 to passively contact the workpiece surface as the robot switches between tools 502 and 504 being in an active position.

FIG. 5A illustrates an embodiment where system 500 alone is sufficient to remove slurry material. The limiting factor to an efficient wiping operation is the removal of water that is taken up by a wiping medium. If a wiping medium can reach a steady state, or close to steady state, where a similar amount of water is driven out of the pad as taken up in wiping slurry, then the wiping medium can engage in a large number of wiping operations before needing to be replaced or treated.

Water may be driven out in a variety of ways. It may be sufficient to use the friction generated by contact between the wiping medium against the surface, or by causing the wiping element to spin in between wiping operations.

It is possible to increase wiping efficiency by causing a robot trajectory to keep an outer portion of the wiping pad engaged with the sanding slurry. FIG. 5B illustrates a schematic of a wiping operation 550 where a wiping element 560 engages a slurry 552 formed in the repair of defect 554. It is noted that, instead of centering wiping element 560 within the slurry 552, or on defect 564, the wiping element is positioned off-center. As illustrated in FIG. 5B, the speed of rotation increases from a center 564 to an edge 562 of wiping element 560. Therefore, a higher friction, and therefore a higher heat, is generated at an exterior edge of wiping element 560 than in a center 564, where the speed is substantially zero. A robot trajectory may be programmed such that wiping element 560 circles inward toward defect 564, such that a center 564 of wiping element 560 does not engage slurry, or only engages slurry after an outer edge of wiping element 560 has passed through the area. In some embodiments, it is not necessary to remove all slurry 552, but only sufficiently wipe the area of defect 554 clear so that it can be imaged and a repair of defect 554 evaluated. In such embodiments, wiping element 560 may move in direction 566, such that an outer portion of wiping element 560 engages slurry before center 564.

FIGS. 5A-5B illustrate embodiments where a wiping element reaches a steady state, or a substantially steady-state operation without external water-removal tools. However, it is expressly contemplated, as discussed herein, that wiping element 560 may also be exposed to, or include, a vacuum or heat source that causes entrained water to evaporate.

It is desired to reduce a wiping operation time as much as possible. Therefore, combinations of robot trajectories, heat sources, vacuum sources, applied force to generate friction, rotational speed, and/or air sources may be used to reduce a time required to wipe a sufficient amount of slurry from defect area. Heat sources may include a heat lamp, such as an infrared heat lamp, or another source. Air sources may include an air stream, a fan, etc. A vacuum may be provided with, or separately from wiping element 560.

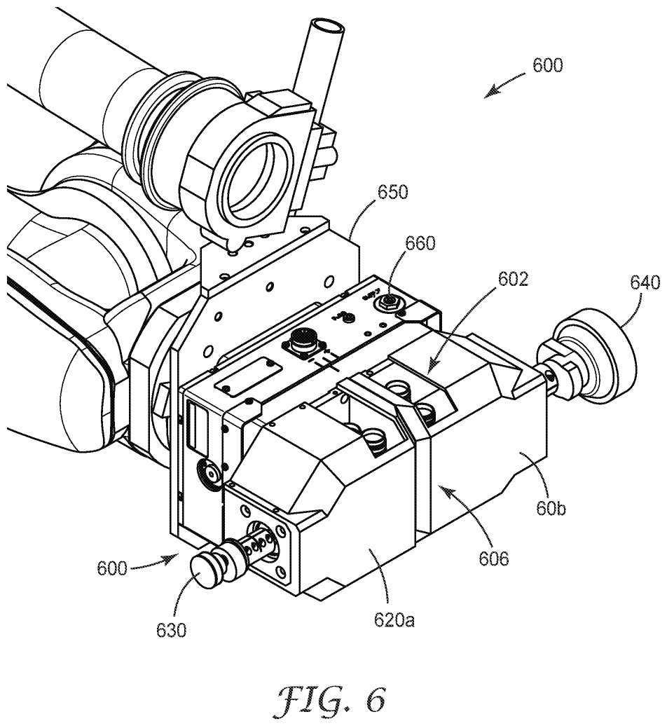

FIG. 6 illustrates a robotic system with fluid removal tool in accordance with embodiments herein. A system 600 may include tools 630 and 640 mounted on end effectors 620a and 620b, which are secured or fastened to a force controller 660. Controller 660 is additionally fastened to the mounting plate 650, which is capable of rotating at least 180 degrees to properly position tools 630 and 640 for processing the workpiece surface. The fluid removal tool described in this application may be fastened or mounted to end effector 620a or 620b at attachment points such as 602, 604, and 606.

The fluid removal tool may, for example, be mounted in either of tool positions 630 or 640, such that a 180-degree rotation of mounting plate 650 swaps the relative positions of tools 630, 640. As part of that motion, in some embodiments, a fluid removal tool may move through the defect repair area.

In one embodiment, the fluid removal tool may be mounted substantially perpendicularly to both tool 630, 640. Such positioning may easily allow for passive wiping or surface cleaning as mounting plate 650 rotates in switching from tool 630 to 640. It may also be beneficial to size the tool mount so that the fluid removal tool is positioned on the radial arc of rotation, to facilitate passive or semi-passive wiping.

In one embodiment, passive wiping includes providing contact between the wiping medium and workpiece surface via mounting plate 650 rotation only, without additional robotic or force controller motion.

In another embodiment, semi-passive wiping includes providing contact between the wiping medium and workpiece surface during rotation of mounting plate 650, but also requires any additional amount of force or motion of the fluid removal tool to facilitate effective contact with the workpiece surface.

Semi-passive wiping may also include providing the wiping medium along a trajectory such that an outer area of the wiping medium engages the defect area first, and entrains more of the liquid than an interior portion of the wiping medium. Semi passive wiping may include selecting a rotational speed, applied force, and lateral movement speed of the wiping medium when in contact with the surface being wiped. Semi-passive wiping may also include a heat source, air source, or vacuum that aids in fluid removal.

In another embodiment, active wiping may include having an additional robotic system or arm to facilitate contact between the fluid removal tool and wiping system. Active wiping may include contact between the fluid removal tool and wiping system which does not take place during rotation of mounting plate 650. Active wiping may include a pneumatic or other motion tool that moves the fluid removal tool.

Additionally, active wiping may also include another fluid removal aid, such as a heat source, air source or vacuum that is provided either while wiping medium contacts a surface, or that is provided to wiping medium in between wiping operations.

In determining placement of the fluid removal tool, consideration must be given to sensor, wiring, and piping requirements of system 600. A passive removal tool, such as a wiping medium, may be more easily placed than an active fluid removal tool, which may have additional mechanical requirements. An air-knife fluid removal tool, for example, may require ample clean dry air or vacuum supply. A fluid removal tool utilizing force control unit 660, another force control unit, or having additional sensor capabilities may have different alignment requirements.

Automating the fluid removal process presents several problems as compared to the manual fluid removal processes currently utilized in industry. Problems arise in guaranteeing sufficient slurry removal. A human operator can observe a worksurface during the wiping process to verify that the fluid or slurry has been effectively removed. While a robot fluid removal system can include optical sensors to provide similar feedback, the timing allotted to a wiping operation is not conducive to an iterative feedback system as every second added increases a required dwell time, reducing a number of repairs that can be done in a work shift. Additionally, as illustrated in FIG. 6, the space available on an end-of-arm system 600 is limited, and additional sensors reduce the space available for tools. Because of the difficulties associated with incorporating additional sensors, in some embodiments, an efficient and predictable fluid removal system that does not require visual verification is incorporated into end-of-arm system 600.

A human operator also has the capability of adjusting application pressure and using random hand movements (e.g. circles and linear wiping patterns) and adjusting or repeating the process as necessary. These variations of pressure and wiping techniques allow for an operator to effectively and reliably clean the workpiece surface. Programming such erratic movements on a robotic counterpart is difficult.

Another variable which is considered by a human operator is the saturation of the wiping medium. As a wiping medium becomes saturated, an operator may make holding adjustments to expose the unsaturated surface area and facilitate more effective fluid removal. A human operator may also be able to detect when the wiping medium needs to be exchanged based on saturation. A human operator can also use a very large wipe (i.e. a large towel) that is difficult for a robot to manipulate. Also, the human operator can quickly discard and grab a new wipe material, where a robot could have a much longer time to complete this change. Described herein are several systems and methods that address these difficulties.

Therefore, it may be desired to select operational parameters that allow a wiping medium to near, or achieve, a steady state operation. This may include automating the slurry-dispensing process such that a known amount of fluid is dispensed consistently. The operation of a wiping system may then be calibrated such that the known amount of fluid can be removed from a surface, and then evaporated or otherwise removed from the wiping medium during each wiping cycle. This may include adjusting a rotational speed, lateral speed, or applied force of the wiping medium. It may also include selecting a trajectory for the wiping medium that causes a majority of the absorbed fluid to be entrained in an outer portion of the wiping medium.

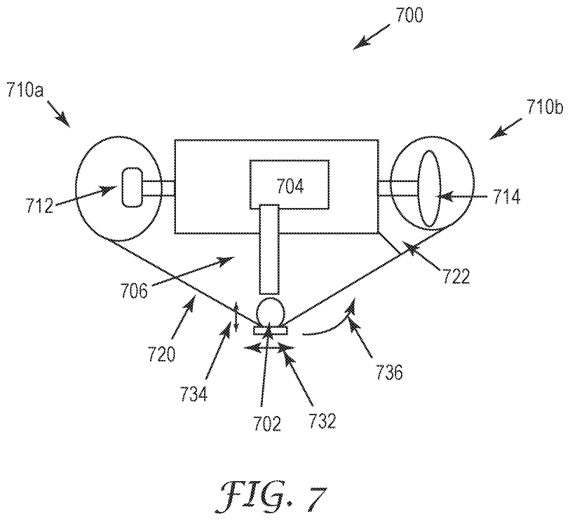

FIG. 7 illustrates a fluid removal system 700 for an end-of arm robotic repair unit. Fluid removal system 700 also allows for a wiping medium to be exposed for wiping a surface as needed. In some embodiments, the wiping medium is an unsaturated wiping medium, e.g. an unsoiled, unused or fresh wiping medium or portion of a wiping medium. In some embodiments, the wiping medium is a previously used wiping medium, e.g. one that has been cleaned, removed of debris, or not yet saturated with slurry material. A wiping medium may continue to be used so long as it sufficiently clears slurry and debris from the surface. In some embodiments, a wiping medium is effective so long as at least 70% of slurry material is removed during an operation. In some embodiments, at least 75% removal of slurry material is required for efficacy, or at least 80%, or at least 85%, or at least 90%, or at least 95%, or at least 98%, or at least 99%.

In some embodiments, a wiping motion causes wiping medium 720 to be released from a first roll 710a, such that, for the next wiping motion, a new portion of wiping medium 720 is exposed.

In another embodiment, wiping medium is unrolled from roll 710a and rolled onto roll 710b, for example periodically or continuously.

In one embodiment, system 700 is mounted to an end of arm system for robotic repair, for example, extending perpendicular to the dual mounted processing tools 712, 714. Fluid removal system 700, in one embodiment comprises a fluid wiping medium 720, which extends from a first roller 710a to a second roller 710b. Wiping medium 720, in one embodiment, is under tension maintained by a support rod 706 and a support node 702. Node 702 creates an apex in the wiping medium which serves as the contact point with the workpiece surface; the shape of node 702 may differ in some embodiments depending on factors such as the wiping medium.

Support rod 706, in one embodiment, is coupled to a motion controller (704) that moves node 702 in directions 732 and 734. This directional control may enable programming of the motion controller to move wiping medium 720 in complex motions that allow for fluid removal system 700 to more efficiently remove fluid. For example, it has been determined that fluid must be removed from a defect area between sanding and polishing steps. However, the fluid does not all need to be captured on wiping medium 720. For example, movement of support rod 706 and node 702 in direction 736 may cause fluid to be flung, or thrown out of the immediate defect area.

The wiping medium, in the embodiment illustrated in FIG. 7, is extended from rolling tool 710a to 710b such that wiping medium 720 is rolled out of one rolling tool (e.g. 710a), over node 702, and wound up on receiving tool (e.g. 710b). This cycle of the wiping medium allows for a fresh or unsaturated supply of wiping medium 720 to be contacted with the workpiece surface, with the soiled medium 720 then being rolled onto 710b.

In one embodiment, system 700 also includes a debris removal tool 722 which may clear a portion of the slurry or debris from medium 720 after it has been used and before it is re-wound. Debris removal tool 722 may be, for example, a scraping, brushing or percussion tool that removes dried, crusted slurry. In some embodiments, the wiping medium may be a continuous belt which wraps around both sides of rolling tools 710a/710b. in another embodiment, debris removal tool 722 may also consist of a more mechanical device, such as an air-knife, vacuum, or rinsing tool. Such a mechanical tool 722 may effectively remove dried particulate matter.

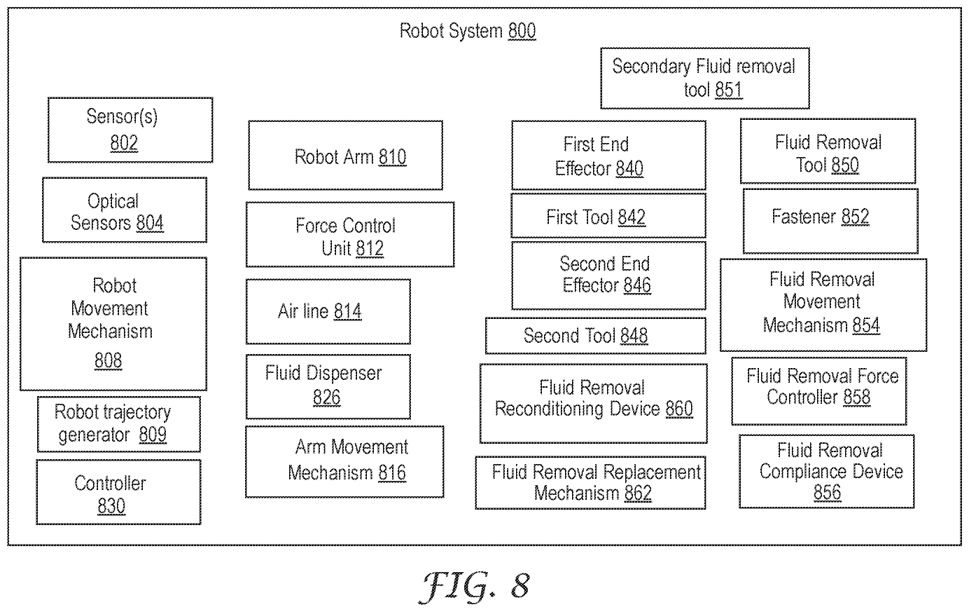

FIG. 8 illustrates a schematic of a robotic repair system 800. Robotic repair system 800 may be useful for sanding and polishing defects on a worksurface in accordance with embodiments herein. The work surface may be a vehicle, in some embodiments, such as an automobile, a car, a truck, a boat, an airplane, helicopter, etc.

Robotic repair system 800, in one embodiment, has optical sensors 804, which may be used to locate paint/clearcoat blemishes or areas to be repaired. Robotic repair system 800 includes a robot moving mechanism 808, which may be used to move an end-of-arm assembly into proximity of a defect repair area. As illustrated in FIG. 8, in one embodiment, robotic repair system 800 includes a controller 830 which controls movement and sensing of robot arm 810 and related components. However, it is expressly contemplated that, in some embodiments, robot arm 810 and/or components mounted thereon have their own controllers which receive and execute movement and sensing commands from controller 830.

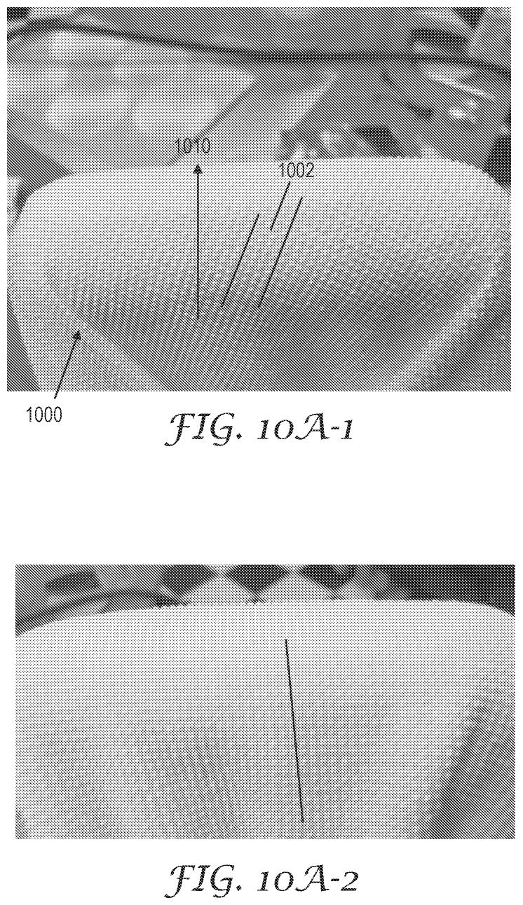

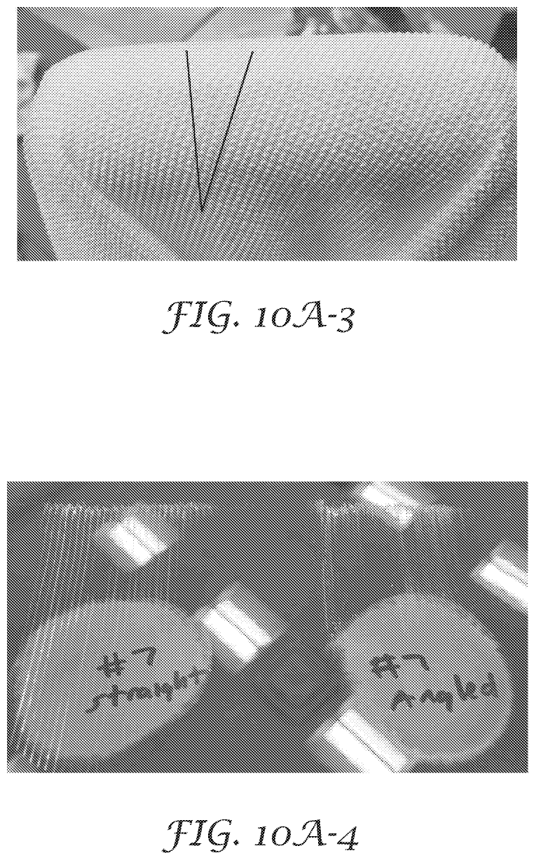

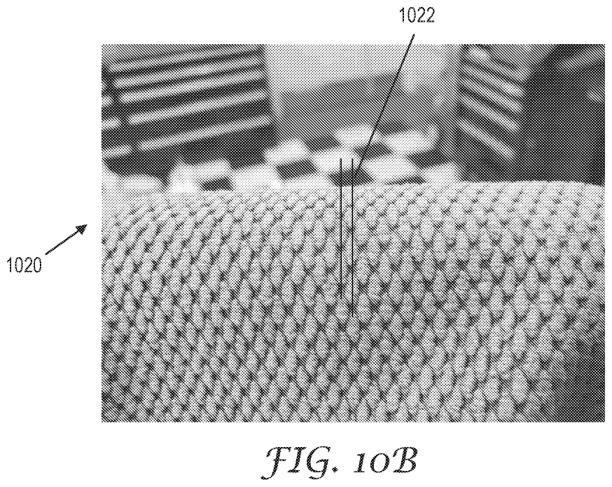

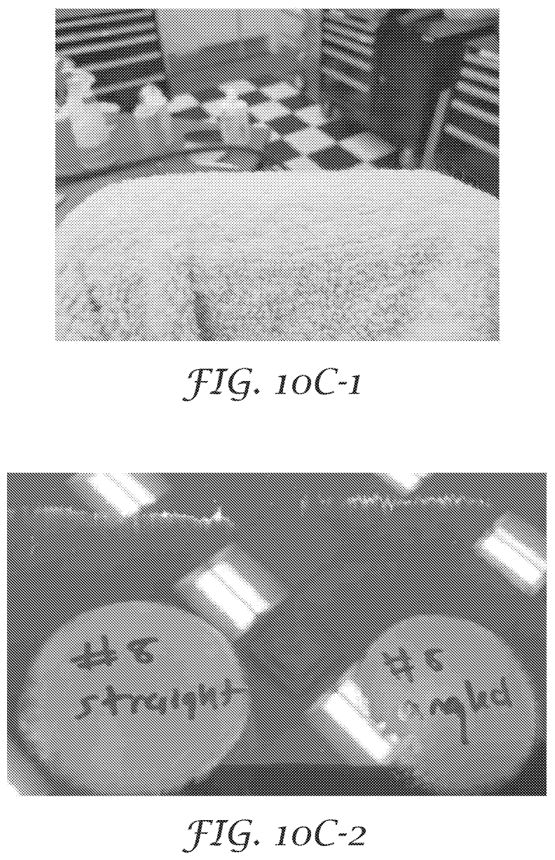

In some embodiments, at the end of robot arm 810 is an end-of-arm assembly which can include a variety of tools, as illustrated in FIGS. 5-7 as well as FIGS. 10-12, for example. However, it is expressly contemplated, as illustrated in FIG. 8, that, in other embodiments, some components may be located elsewhere on one or more motive robot arms 810.

A first abrasive tool 842 may be mounted on robot arm 810. The first abrasive tool, in some embodiments, is coupled to a first end effector 840. In some embodiments, a second abrasive tool 848 is mounted to robot arm 810. Second tool 848 may be coupled to a second end effector 846. A fluid removal mechanism 860 may be mounted to a robot arm 810. However, it is expressly contemplated that, in some embodiments, some of these components may on more than one robot arm 810. For example, a first robot arm 810 could support a first abrasive tool 842, e.g. a sanding robot with a sanding tool, and a second robot arm 810 could support a second abrasive tool, e.g. a polishing robot with a polishing tool.

In one embodiment, robot arm 810 is moved into place by arm movement mechanism 816. Abrasive tools 842, 848 and fluid removal system 860 may also be moved into place by arm movement mechanism 816, in one embodiment, or may each have their own movement mechanism that moves them into position on workpiece surface.

A force control unit 812 may also be located on robot arm 810 to control interactions between the robot arm 810, end effector systems, and a workpiece surface.

In some embodiments, air line 814 and fluid dispenser 826 feed from robot arm 810 to the end effector system to provide necessary air and fluid supply for operating first tool 842 and second tool 848.

In an embodiment, fluid removal tool 850 is also coupled to force control unit 812. Fluid removal tool 850 may be, for example, a fabric-based wiping medium, an air knife, a vacuum system, or another suitable tool. However, it is also contemplated that, in some embodiments, fluid removal tool 850 is coupled to a separate force control unit than that used for tool 842 or tool 848. It is also contemplated that, in other embodiments, fluid removal tool 850 is a passive tool with no associated force control unit. In some embodiments, fluid removal tool 850 is mounted in a fixed position on robot arm 810. A fastener 852 may be used to fix fluid removal tool 850 in a position to allow for passive wiping, in some embodiments. Fastener 852 may be extendable, or coupled to force control unit 812 to facilitate semi-passive wiping, in some embodiments.

Robot arm 810 may also include a fluid removal compliance device 856 which may provide force compliance for the fluid removal tool 856. Fluid removal compliance device 856 may be a passive compliance device, such as a flexible or compressible material that urges a wiping medium toward a worksurface. In other embodiments, fluid removal compliance device 856 is a mechanical device, such as a mechanical spring or a pneumatic air cylinder.

In some embodiments, fluid removal tool 850 may be moved through space using a fluid remover movement mechanism 854. Movement mechanism 854 will control variables such as the pitch, tilt, and yaw of an active wiping motion of fluid removal tool 850. A robot trajectory generator 809 generates a trajectory for fluid removal tool 850 and/or fluid removal compliance device 856 such that an outer portion of the surface area of fluid removal tool 850 encounters an area of a surface with fluid.

In some embodiments fluid removal tool 850 may function in conjunction with fluid removal force control unit 858. Force control unit 858 may maintain proper force or pressure between fluid removal tool 850 and the workpiece. Fluid removal force control unit 858 may be mounted to robot arm 810, and supply signal or control through fastener 852 to fluid removal tool 850. In other embodiments, pressure or tension on the workpiece surface is regulated by fluid removal compliance device 856.

Fluid removal tool 850 may function in conjunction with a fluid removal reconditioning device 860, in some embodiments. Reconditioning device 860 may be a vacuum, brush, or scraping tool used to remove particulate matter, debris, liquid or slurry from the wiping medium of fluid removal tool 850. Reconditioning device 860 may also be a heat source, air source or other water evaporator. For example, in between wiping operations, fluid removal tool 850 may be positioned near a heat lamp or fan. Reconditioning device 860 may help to provide a suitably absorbent and effective wiping medium for cleaning the workpiece surface more than once.

In another embodiment, fluid removal tool 850 may include a replaceable component, for example a new absorbent pad when an old one is saturated with fluid or debris. A fluid removal replacement mechanism 862 may facilitate replacement of the wiping medium fluid removal tool 850. In some embodiments, replacement mechanism 862 is a release clip, button or hook and loop system used to quickly exchange saturated or exhausted wiping medium.

However, in some embodiments, fluid removal tool 850 is intended to operate at a substantially steady state, such that a single fluid removal tool can operate for a large number of wiping operations, e.g. more than 10, more than 50 or even more than 100 operations, prior to needing to be replaced. This may be achieved by operating robot system 800 such that fluid removal tool 850 releases as much fluid as it takes up during a wiping operation. Fluid may be removed from fluid removal tool 850, for example using a secondary fluid removal tool 851, such as a heat source, air flow source, or vacuum source that is applied either during a wiping operation or in between subsequent wiping operations. Fluid may also be removed by heat caused by the friction of fluid removal tool 850 against a surface. Additionally, the uptake of fluid may be controlled by robot trajectory generator 809 moving fluid removal tool 850 such that fluid is entrained in an outer area of fluid removal tool 850, where higher rotational speeds generate more friction, and therefore more heat, that will help the entrained fluid be released through evaporation or centrifugal force.

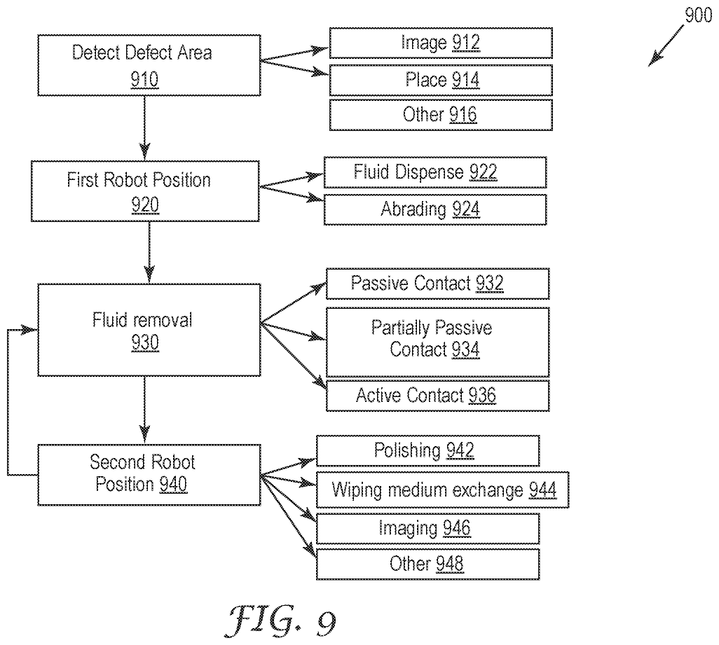

FIG. 9 illustrates a method of repairing a defect area on a worksurface in accordance with embodiments of the present invention. Method 900 may be useful for any of the systems described with respect to FIGS. 5-10. However, method 500 may also be implemented with another suitable robotic repair system.

In block 910, a surface repair system images, as illustrated in block 912, the workpiece to identify and locate a defect for repair, for example a blemish on a paint or clearcoat surface. A motive robot arm may then position the general position of the robot arm, and place the end-of-arm system over the defect area to allow tool access to the workpiece, as illustrated in block 914. Detecting a defect may also include other detection and locating methods or steps, as illustrated in block 916. Imaging a surface and moving a robot into position may on a series of sensors and movement controllers such as those described in FIG. 8

In block 920, the robot repair system places a first tool in position to repair a detected defect. This may include moving a sanding tool in contact with a surface. The workpiece is processed using a first tool. Processing a workpiece surface often includes the dispensing of fluid 922, such as water or an abrasive or polish solution to be used in processing. Sanding a surface often creates a particulate slurry or suspension on the worksurface.

In block 930, fluid is removed from the worksurface. Fluid removal may take place as the end-of-arm assembly transitions from a first position to a second position. The fluid removal step is intended to clear the workpiece surface before a second abrading step. In some embodiments, this fluid removal step may be accomplished using passive contact, as indicated in block 932, such as dragging a cloth or sponge across the surface. In some embodiments, fluid removal includes semi-passive contact, as indicated in block 934, such as a mobile portion that applies force or moves a sponge or cloth across the worksurface. In some embodiments, fluid removal includes active contact, as indicated in block 936, such as a vacuum, air knife or other active wiping mechanism.

A passive fluid removal step may allow for a fluid removal tool to contact or interact with the workpiece surface consequently as an end-of-arm assembly robot transitions, with no additional input or movement from a force or motion controller. In some embodiments, the fluid removal tool may be fixed in a position located on the art of robot rotation to facilitate such contact. A partially passive fluid removal step may take place as an end-of-arm assembly robot transitions, but may require additional input or movement from a force or motion controller.

In some methods, a robot will transition into a second robot position, e.g. block 940, after first processing the workpiece in a first position, e.g. block 940, with a fluid removal step in between.

Removing fluid from the worksurface may include, in some embodiments, a fluid removal tool operating at, or near, steady state conditions with respect to water uptake. If steady state can be achieved with regard to water entrained within a fluid removal tool, then a replaceable component, such as a pad, brush or other absorbent material, the useful lifespan will be greatly extended. A pad may then be replaced contingent on loading of polishing material and abrasive debris, or wear of the pad itself. If the pad, instead, had to be exchanged based on entrained fluid, it would have to be exchanged every few cycles. Operational parameters of the robot can be selected, such as lateral movement speed and rotational movement speed of the fluid removal tool, the force applied to the fluid removal tool, the amount of fluid dispensed, as well as the use of a secondary fluid removal tool, such as a heat source, air source or vacuum source.

It is also expressly contemplated that steady state or near-steady state may be achieved for the polish as well, in some embodiments. When the water of the polishing material evaporates, it leaves behind polish particles which then becomes dry and loose and can be removed by knocking the pad, free-spinning the pad, or may fall off as the pad otherwise moves or spins against a surface.

In block 940, the robotic repair unit may be in a second position such that a second tool interacts with the workpiece. For example, after a sanding step, it may be necessary to polish the worksurface, as indicated in block 942. It may also be useful, in some embodiments, to image the worksurface after fluid has been removed, as indicated in block 946. A second position may also facilitate exchanging a wiping medium, as indicated in block 944, for example replacing a saturated wiping medium with a new, or less saturated, replacement. Other actions that may be taken by a robotic repair unit are also envisioned, as indicated in block 948.

The fluid removal tool of the present invention may be a sponge or cloth-like material which would function as a wiping medium. A wiping medium with high absorbency potential should be chosen to maximize the efficiency of slurry removal from the workpiece surface. The wiping medium should also have a high saturation capacity to prevent sloppy or inefficient fluid removal. A wiping medium made of channeled or woven material may provide for improved slurry capture and result in a cleaner workpiece surface with fewer streaks. This wiping medium may be fastened to the end effector in conjunction with a force controller, or may be fastened with a pneumatic, spring, or otherwise compliant system to ensure ideal pressure placement on the workpiece surface.

FIGS. 10A-10C are examples of possible wiping mediums to be used as a fluid removal tool. Medium 1000, illustrated in FIG. 10A-1 has a surface that includes raised bumps that create liner channels such as those illustrated by lines 1002. Wiping a surface with medium 1000 in a single motion may leave material behind in lines where channels 1002 moved over the surface. Instead, it may be possible to rotate medium 1000, such that it is pulled along a surface at an angle with respect to channels 1002, as indicated by arrow 1010. However, other angles are expressly envisioned, for example anywhere from 5°-175° may be suitable. Performance of medium 1000 can be seen in FIG. 10A-4. Two orientations of medium 1000 were tested, including a straight orientation, e.g. illustrated in FIG. 10A-2, and an angled orientation, illustrated in FIG. 10A-3. As illustrated in FIG. 10A-4, both the straight and angled orientation removed some of the slurry mixture, however the angled orientation performed better. Slurry material caught in channels 1002 of medium 1000 in the straight orientation left behind streaks.

In FIG. 10B, a wiping medium 1020 is illustrated. Medium 1020 includes rows 1022 of raised portions that are offset from adjacent portions such that there are no channels. Wiping medium 1020 may be preferred over medium 1000 because it may be more likely to leave less residue behind.

FIG. 10C illustrates a wiping medium 1040 demonstrates a wiping material with no distinct channels or raise portions. Wiping mediums 1000, 1020 and 1030 are all microfiber materials. However, similar results may be seen with other fabrics. Microfiber materials may be preferred, however, because they have higher absorption than other fibers. Microfiber, as used herein, refers to a fine synthetic textile fiber, typically with fibers finer than 1 denier. Microfibers may be made from polyamide, polyester, polypropylene, or another suitable material. Microfibers may be extruded, and mechanically or chemically processed to be split into finer particles, which may create a positive charge within the fiber. The fibers are then woven in a flat or looped weaves. Loop weaved microfibers may be preferred as the web of fabric may be better able to remove and absorb debris and fluids.

Microfiber materials are typically rated in grams per square meter (GSM), which is a measurement of density but often referred to as the weight. In some embodiments herein, microfiber wiping mediums are at least 200 GSM, or at least 250 GSM, or at least 300 GSM, or at least 350 GSM, at least 400 GSM, at least 500 GSM, or even more dense. FIGS. 10A and 10B illustrate lower pile weaves than FIG. 10C-1, which illustrates a higher pile weave 1030. As illustrated in FIG. 10C-2, the higher pile weave fabric 1030 shows improved wiping when used either in a straight orientation or an angled orientation.

However, while straight or angled orientation is described for the purposes of understanding, it is expressly contemplated that other movements may be possible, for example a tool capable of rotary, orbital or random orbital movement may be coupled to the wiping medium.

Improvement in wiping quality is seen with the increase in available surface area which is correlated to the increase in pile, or length of fibers in the loop portion of a loop weave. Additionally, a quantity of wiping operations increases with the increased available surface area. Wiping medium 1000, for example, became saturated after 5 sanding repair operations.

However, in a given work shift, as many as 2000 defect repair operations may be undertaken. It is desired to have a wiping solution that can last for a significant portion of a work shift that it is not a burden to replace.

One potential solution is to increase the size of a wiping medium. For example, human operators often use buff pads much larger than the sanding tools used by robotic repair units. However, smaller wiping units are preferred as the defects being repaired may be on contoured surfaces. The wiping unit should be able to get into the contours of a vehicle body. It is preferred to have a wiping unit with a similar footprint area to a sanding or polishing tool used by a robotic repair unit.

It was discovered that rotating the wiping tool, while in contact with the worksurface, generated sufficient heat such that at least a portion of the moisture being removed was able to evaporate. Additionally, cycle time required to remove the fluid was discovered to be greatly reduced when the wipe was rotated as compared to when it was simply translated over the slurry. It was therefore found that the wiping area of a wiping tool could be smaller, and the tool still last for a significant number of wiping operations without becoming fully saturated. For example, by generating heat sufficient to cause evaporation of entrained fluid, it may be possible to considerably increase an amount of slurry that can be removed from a surface by a single wiping tool, thereby extending the number of sanding operations that may be completed. It may even be possible to near steady state operation with respect to liquid uptake, for example by causing nearly, or as much entrained liquid to evaporate as is absorbed during an operation.

FIGS. 11A and 11B illustrate wiping systems in accordance with embodiments herein. A wiping system 1100 includes an absorbent wiping unit 1110 coupled to a motive unit 1102. Motive unit 1102 may be able to move in the z-axis direction closer to, or further away, from a worksurface. Z-axis movement may be accomplished using an electronic or pneumatically powered motor that moves wiping unit closer to, or further away from, a robot arm. Motive unit 1102 may be coupled to a compliance unit 1104, which may couple directly to wiping unit 1110. Compliance unit 1104 may be a backup pad, in some embodiments, or a compliant interface pad, as illustrated in FIG. 11A. Motive unit 1102 may also be able to rotate, for example as indicated by arrow 1108.

Absorbent wiping unit 1110 may be characterized as having a backing 1118 with a plurality of protrusions 1106. Backing 1118 may have substantially the same width as the width of compliant unit 1104, as illustrated in FIG. 11A. As illustrated in FIG. 11A, in some embodiments, wiping unit 1110 is a micro chenille wipe, consisting of several microfiber strands woven to form protrusions 1112, each of which has a length 1116 and a diameter 1114. As illustrated in FIG. 11A, length 1116 is larger than diameter 1114. In some embodiments, length 1116 may be less than 10× larger than diameter 1114, in some embodiments. However, as illustrated in FIG. 11B, in some embodiments, length 1116 is more than 10× larger than diameter 1114. The surface area available using wiping unit 1110 is much greater than using wiping mediums 1000, 1020 or 1030 coupled to compliant unit 1104.

When tested in comparison to the wiping mediums 1000 and 1030, wiping unit 1110 lasted through 200 debris repair operations without saturating.

In addition to increased surface area, wiping system 1100 may increase the number of consecutive repair operations that can be undertaken without saturation in two other ways, through rotation and heat generation.

In some embodiments, system 1100 can move in the z-direction such that protrusions 1112 are pressed into a surface by compliant unit 1104 while motive unit 1102 rotates. This generates friction, which may provide sufficient heat that some of the absorbed liquid evaporates. Additionally, rotation may continue while motive unit 1102 is raised away from a worksurface, which may eject some liquid or debris from protrusions 1112.

It may also be possible to increase the number of repair operations by periodically brushing off, knocking free or otherwise removing debris from wiping unit 1110, for example by brushing protrusions 1112 against a rough surface, a bristled brush or another surface.

It may be possible, in some embodiments, to reach, or near, a steady state operation where substantially the same amount of fluid is taken up as is evaporated or knocked off during each new wiping operation. Achieving or nearing a steady state may refer only to uptake of water, such that the same amount of water absorbed as part of the slurry is discharged either due to evaporation to being flung from wiping unit 1110. In a water steady-state operation, debris may still accumulate on the surface of wiping unit 1110. In other embodiments, while steady state is not reached, the wiping unit 1110 lasts for over 100 sanding operations, or over 200 sanding operations, or over 300 sanding operations, or over 500 sanding operations, or over 1000 sanding operations.

In some embodiments, efficacy of wiping unit 1110 can be measured in the amount of slurry or debris removed from a worksurface before the wiping unit 1110 is saturated or no longer sufficiently removes debris from the worksurface.

When wiping unit 1110 is sufficiently saturated with debris, it may be replaced or reconditioned. Replacement may include removing wiping unit 1110, for example by detaching it from compliant pad 1104 such that a new or reconditioned wiping unit 1110 can be attached. For example, a hook and loop attachment may be used between wiping unit backing 1118 and compliant unit 1104.

Reconditioning wiping unit 1110 may include running it through a washing or drying cycle after removal from compliant pad 1104, in some embodiments. In some embodiments, however, at least some reconditioning can be done while wiping unit 1110 is coupled to motive unit 1102, for example by engaging a rough surface or a bristled surface to dislodge dried debris from the surface of protrusions 1112.

FIG. 11B illustrates another embodiment of a wiping assembly 1150 where a wiping unit 1160 is attached to a motive arm 1152. Wiping unit 1160 has a backing with a width 1162 that is similarly sized to the width at the point where wiping unit 1160 couples to motive arm 1152. Motive arm 1152 may be able to move wiping unit 1160 in the z-direction, e.g. down, toward a surface, and up, away from the surface. Motive arm 1152 may also be able to spin, for example as indicated by arrow 1168.

Wiping unit 1160 includes a number of strands extending from the backing, each with a strand length 1164. FIG. 11B illustrates an embodiment where strands have a length 1168 that is more than 10× the size of a strand thickness.

Wiping systems 1100 and 1150 are illustrated in FIGS. 11A and 11B in isolation, however it is expressly contemplated that, in some embodiments, that one or more tools or fluid dispensers are mounted on the same motive robotic system as wiping systems 1100, 1150.

As discussed above, wiping systems 1100, 1150 are advantageously placed on a motive robot arm such that they do not add significant time to a repair process. Therefore, it may be advantageous, in some embodiments, to place a wiping system 1100, 1150 on the same motive robot as one of either a sanding or polishing tool. In one embodiment, wiping system 1100, 1150 is in line with an abrasive tool, for example adjacent a tool on a rail system, such that the wiping system can be moved into position without significant movement of the motive arm. In another embodiment, the wiping system is adjacent to the abrasive tool, but the motive arm must move linearly to put the wiping system into position over a sanded or polished area. The wiping system may share a force control unit with an abrasive tool, in some embodiments. The wiping system may share a movement control system with an abrasive tool, in some embodiments.

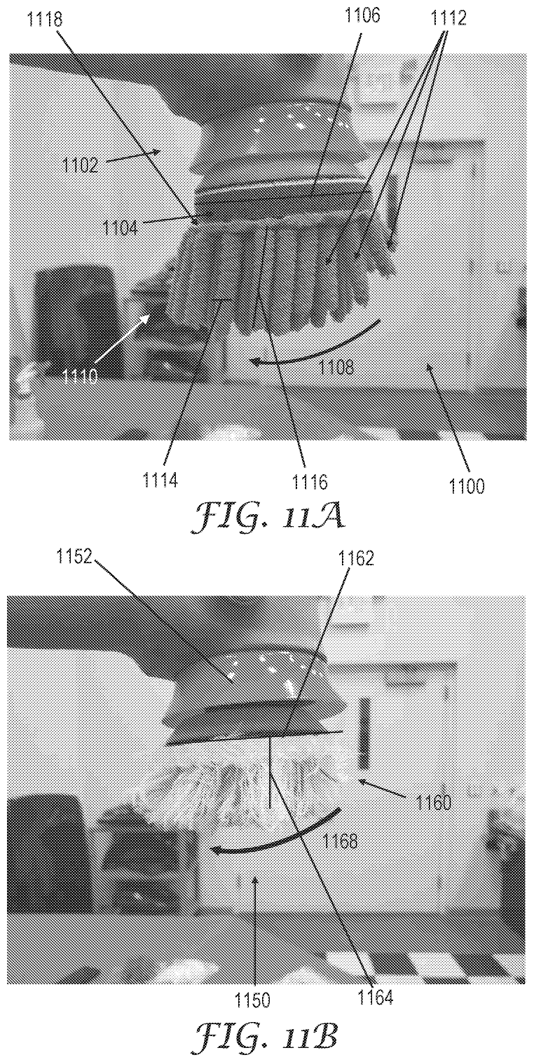

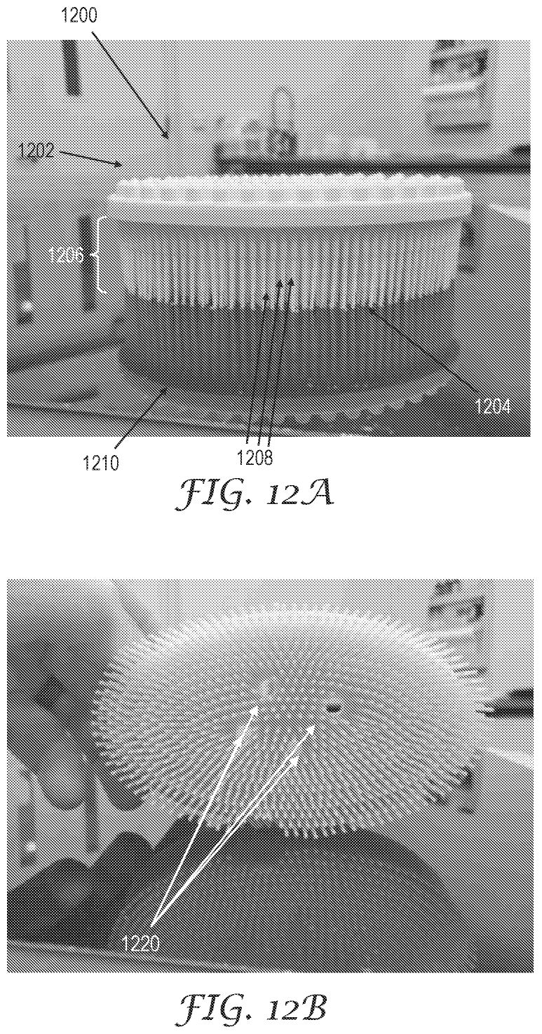

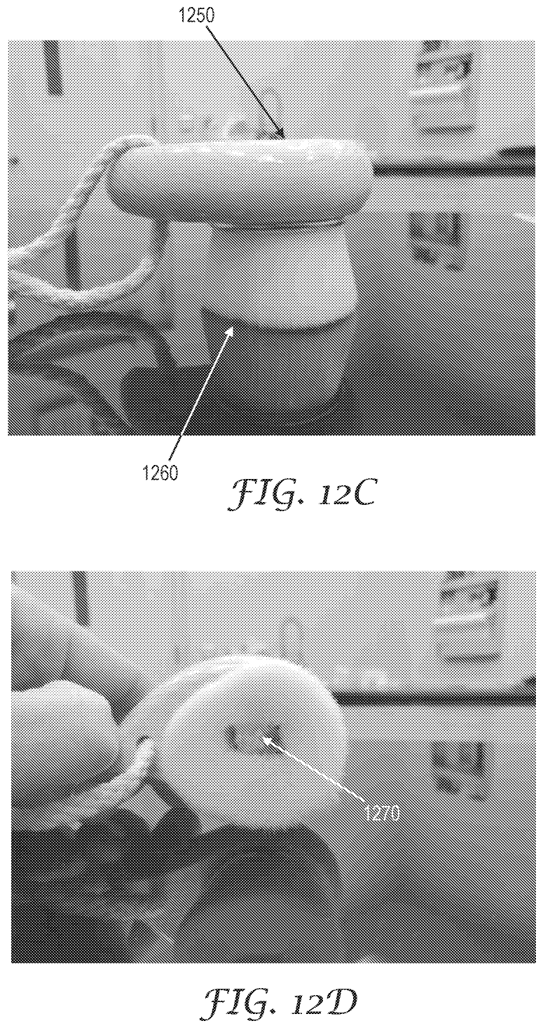

As described above, in some embodiments, a fluid removal system is an active fluid removal system, such as a vacuum. However, it was seen that when a vacuum was applied the water of a slurry was easily removed, leaving behind a film of debris that is well adhered to the paint surface. The debris film is removable once dislodged, however nothing should be used to dislodge the debris that could result in scratching of the surface. Instead, if the vacuum is provided through a bristled surface, with bristles that have a low risk of scratching the paint surface, then the slurry debris can be easily removed. FIGS. 12A-12D illustrate views of vacuum attachments that may be used in accordance with embodiments herein. FIG. 12A illustrates a side view of a brush 1200 with a vacuum attachment side 1202 and a surface contacting side 1204, which contacts a surface 1210. Bristles 1208 extend from a backing for a length 1206. When brush 1200 is moved across surface 1210, bristles 1208 dislodge debris stuck to surface 1210.

FIG. 12B illustrates an underside view of a brush 1200, illustrating a plurality of vacuum holes 1220, through which a vacuum may be pulled.

FIG. 12C illustrates a side view of a brush 1250, with a plurality of bristles 1260 and a vacuum hole 1270 extending through brush 1250. Bristles 1260 are much closer together than bristles 1208. Bristles 1260, 1208, in some embodiments are made of a material that allows them to flex, bend or compress in response to force such that the surface is not scratched. Silicone, compliant polymer or plastic, hair, or another suitable material may be used for bristles 1208, 1260.

A wiping system for a robotic repair unit is presented that includes a motive robot arm with a motor, a connection mechanism coupled to the motive robot arm, and a wiping medium coupled to the connection mechanism. The wiping medium includes a base layer and a plurality of features extending from the base layer. The motive robot arm, powered by the motor, moves the wiping medium. The motive robot arm is configured to move the wiping medium toward, or away from, a worksurface. The motive arm is configured to press the wiping medium toward the worksurface during a wiping operation. During the wiping operation, the wiping medium is driven by a wiping motor against the surface.

The system may be implemented such that each of the plurality of features has a feature height and a feature thickness, and wherein the feature height is greater than a thickness of the base layer.

The system may be implemented such that the feature height is at least twice the feature thickness.

The system may be implemented such that the feature height is less than ten times the feature thickness.

The system may be implemented such that the wiping medium comprises microfiber.

The system may be implemented such that the wiping medium is chenille microfiber.

The system may be implemented such that it includes a compliant layer between the wiping medium and the motive robot arm.

The system may be implemented such that the wiping motor moves the wiping medium in an oscillating or vibratory movement pattern.

The system may be implemented such that the wiping motor is separate from the motor.

The system may be implemented such that the wiping motor drives the wiping medium at a first speed during the wiping operation and spins the wiping medium at a second speed when the wiping medium is moving away from, or toward, the worksurface. The second speed is higher than the first speed.

The system may be implemented such that the connection mechanism comprises a hook and loop system.

The system may be implemented such that it includes a force control unit.

The system may be implemented such that the wiping motor moves the wiping medium in a rotary motion pattern.

The system may be implemented such that the wiping motor moves the wiping medium in an orbital motion pattern.

The system may be implemented such that the wiping motor moves the wiping medium in a random orbital motion pattern.

The system may be implemented such that the wiping motor is an electric motor.

The system may be implemented such that the wiping motor is a pneumatic motor.

The system may be implemented such that the wiping medium is unsaturated after 10 sanding operations.

The system may be implemented such that the wiping medium is unsaturated after 50 sanding operations.

The system may be implemented such that the wiping medium is unsaturated after 200 sanding operations.

The system may be implemented such that the wiping medium is unsaturated after 1000 sanding operations.

The system may be implemented such that the wiping medium removes 75% of a slurry after 50 sanding operations.

The system may be implemented such that the wiping medium removes 85% of a slurry after 100 sanding operations.

A wiping system for a robotic repair unit is presented that includes a motive robot arm with a motor, a connection mechanism coupled to the motive robot arm and a wiping medium coupled to the connection mechanism. The wiping medium comprises a base layer and a plurality of features extending from the base layer. The motive robot arm, powered by the motor, moves the wiping medium. Each of the plurality of features has a feature height and a feature thickness. The feature height is greater than a thickness of the base layer. The feature height is at least twice the feature thickness or the feature height is less than ten times the feature thickness.

A wiping system for a robotic repair unit is presented that includes a motive robot arm with a motor, a connection mechanism coupled to the motive robot arm, a compliant layer between the wiping medium and the motive robot arm and a wiping medium coupled to the connection mechanism. The wiping medium includes a base layer and a plurality of features extending from the base layer. The motive robot arm, powered by the motor, moves the wiping medium.

A robotic paint repair system is presented that includes a force control unit, a first tool system comprising a first end effector coupled to a first tool configured to contact a workpiece, a second tool system comprising a second end effector coupled to a second tool configured to contact the workpiece, and a fluid removal tool comprising a wiping medium, the fluid removal tool being coupled to a motive robot arm. The fluid removal tool is configured to remove fluid from the workpiece. In a first state, the first tool is in position to contact and prepare the object surface and, in a second state, the second tool in position to contact and prepare the workpiece, in a third state, the fluid removal tool is in position to contact the workpiece. The motive robot arm is configured to move the wiping medium toward, or away from, a worksurface. The motive arm is configured to press the wiping medium toward the worksurface during a wiping operation. During the wiping operation, the wiping medium is driven by a wiping motor against the surface.

The system may be implemented such that the first tool and the second tool are mounted to a single robotic repair unit.

The system may be implemented such that the first tool and the fluid removal tool are mounted to a single robotic repair unit.

The system may be implemented such that the first and second tools are positioned at least 90 degrees apart on the motive robot arm.

The system may be implemented such that the fluid removal tool is mounted perpendicular to the first and second tools.

The system may be implemented such that the wiping medium comprises a water-absorbent material.

The system may be implemented such that the fluid removal tool comprises a vacuum.

The system may be implemented such that the fluid removal tool comprises an air knife.

The system may be implemented such that the wiping medium comprises microfiber.

The system may be implemented such that the wiping medium comprises a chenille microfiber.

The system may be implemented such that the wiping medium has an attachment diameter where it attaches to the robotic repair unit, and wherein a plurality of absorbent units extend away from an axis defined by the attachment diameter, and wherein each of the absorbent units comprises a plurality of microfiber strands.

The system may be implemented such that the microfiber is at least 300 gpsm.

The system may be implemented such that the wiping motor moves the wiping medium in an oscillating or vibratory movement pattern.

The system may be implemented such that the fluid removal tool comprises a compliance device.

The system may be implemented such that the compliance device is a compliant material.

The system may be implemented such that the wiping motor drives the wiping medium at a first speed during the wiping operation and spins the wiping medium at a second speed when the wiping medium is moving away from, or toward, the worksurface, wherein the second speed is higher than the first speed.

The system may be implemented such that after 10 sanding operations, the wiping medium removes at least 70% of the slurry from the surface.

The system may be implemented such that after 100 sanding operations, the wiping medium removes at least 70% of the slurry from the surface.

The system may be implemented such that after 200 sanding operations, the wiping medium removes at least 70% of the slurry from the surface.

The system may be implemented such that the fluid removal tool is fastened directly to the first end effector.

The system may be implemented such that the fluid removal tool is coupled to a force control unit.

The system may be implemented such that the first tool is coupled to the force control unit.

The system may be implemented such that the fluid removal tool is fastened to the end effector system using a compliant fastener.

The system may be implemented such that the wiping medium comprises a sponge.

The system may be implemented such that the wiping medium is a textile.

The system may be implemented such that the wiping medium is angled with respect to a workpiece surface.

The system may be implemented such that the textile comprises a plurality of raised portions arranged in rows, and wherein a plurality of channels are formed by the arranged rows.

The system may be implemented such that the wiping medium is positioned such that the plurality of channels are at an angle with respect to the direction of wiping.

The system may be implemented such that the textile comprises a plurality of raised portions, wherein a first row of raised portions is offset from a second row of raised portions such that the textile is free of channels.

The system may be implemented such that the textile is substantially free of channels.

The system may be implemented such that the wiping medium is removable from the robotic repair system using a connection mechanism.

The system may be implemented such that the wiping medium is a single-use wiping medium, comprising the connection mechanism for connecting to the fluid removal tool. The single-use wiping medium is saturated after a single wiping operation.

The system may be implemented such that the connection mechanism is a fastener.

The system may be implemented such that the connection mechanism is compliant.

The system may be implemented such that the connection mechanism comprises a hook and loop system.

The system may be implemented such that the fluid removal tool comprises a roll-to-roll system. The wiping medium is unrolled from a first roller and rolled onto a second roller.

The system may be implemented such that the wiping medium is a belt stretched over a first roller and a second roller, and wherein the first roller is spaced apart from the second roller.

The system may be implemented such that the wiping medium is indexed after each use, such that a first portion of the wiping medium is unrolled from the first roller and a second portion is rolled onto the second roller. The first portion has a first area, the second portion has a second area, and the first and second areas are substantially similar in size.

The system may be implemented such that the wiping medium is under tension.

The system may be implemented such that tension is applied by a tension rod.

The system may be implemented such that the tension rod is compliant.

The system may be implemented such that the roll-to-roll system comprises a debris removal mechanism, that removes debris from the second portion.

The system may be implemented such that the roll-to-roll system comprises a debris removal mechanism, that removes debris from the second portion.

The system may be implemented such that it also includes an air stream directed at the second portion.

The system may be implemented such that the debris removal mechanism comprises a pin, a scraper, or a percussion tool.

The system may be implemented such that the fluid removal tool is fastened in a position to allow access to the workpiece surface as the system transitions from the first tool to the second tool

The system may also include a sensor configured to detect a working state of the defect repair system and a control circuit to receive signals from the sensors and process the signals to generate state information of the defect repair system.

The system may be implemented such that the defect repair system is mounted to a motive robot arm.

The system may be implemented such that the compliant fastener comprises a pneumatic cylinder, a linear servo drive, an air force control, a hydraulic cylinder, a rubber pad or a spring.

A robotic paint repair system is presented that includes a force control unit, a first tool system comprising a first end effector coupled to a first tool configured to contact a workpiece, a second tool system comprising a second end effector coupled to a second tool configured to contact the workpiece and a fluid removal tool configured to remove fluid from the workpiece. The fluid removal tool is fastened directly to the first end effector. In a first state, the first tool is in position to contact and prepare the object surface and, in a second state, the second tool in position to contact and prepare the workpiece, in a third state, the fluid removal tool is in position to contact the workpiece.

A robotic paint repair system is presented that includes a force control unit, a first tool system comprising a first end effector coupled to a first tool configured to contact a workpiece, a second tool system comprising a second end effector coupled to a second tool configured to contact the workpiece, a fluid removal tool configured to remove fluid from the workpiece wherein the fluid removal tool is coupled to a force control unit. In a first state, the first tool is in position to contact and prepare the object surface and, in a second state, the second tool in position to contact and prepare the workpiece, in a third state, the fluid removal tool is in position to contact the workpiece.

A method of repairing a workpiece is presented that includes contacting the workpiece using a first tool. The first tool is attached to a first end effector aligned to process the workpiece surface. The first end effector is coupled to a first force control unit mounted to an end-of-arm portion of a robotic repair unit, wherein the first tool is an abrasive tool. The method also includes removing fluid from the workpiece, using a fluid removal tool coupled to the robotic repair unit. The fluid removal tool is a wiping medium, and wherein the wiping medium comprises an absorbent material. The method also includes contacting the workpiece using a second tool. The second tool is a second abrasive tool.

The method may be implemented such that the fluid removal tool is actuated during a movement of the end-of-arm portion of the robotic repair unit.

The method may be implemented such that the first tool is a sanding tool.

The method may be implemented such that the second tool is a polishing tool.

The method may be implemented such that the first and second tools are both mounted to the end-of-arm portion of the robotic repair unit, and the first and second tools are mounted at least 90 degrees apart.

The method may be implemented such that the fluid removal tool is mounted perpendicular to one of the first and second tools.

The method may be implemented such that the wiping medium comprise a backing and a plurality of protrusions extending from the backing.

The method may be implemented such that each of the plurality of protrusions comprises a strand of fibers.

The method may be implemented such that the absorbent material is a microfiber.

The method may be implemented such that the absorbent material is a chenille microfiber.

The method may be implemented such that the microfiber is at least 200 g/sqm.

The method may be implemented such that the microfiber is at least 300 g/sqm.

The method may be implemented such that the microfiber is at least 400 g/sqm.

The method may be implemented such that the microfiber is at least 500 g/sqm.

The method may be implemented such that the fluid removal tool is a vacuum.

The method may be implemented such that it also includes a debris removal attachment.

The method may be implemented such that the debris removal attachment comprises bristles.

The method may be implemented such that the fluid removal tool is an air knife.

The method may be implemented such that the fluid removal tool is coupled to a fluid removal force control unit.

The method may be implemented such that the fluid removal tool is coupled to a motion controller.

The method may be implemented such that the motion controller moves the fluid removal tool closer or further from the workpiece.

The method may be implemented such that the motion controller spins the fluid removal tool.

The method may be implemented such that the wiping medium is a sponge.

The method may be implemented such that the wiping medium is a textile with a plurality of channels.

The method may be implemented such that the wiping medium comprise a plurality of channels defined by raised portions, and the wiping medium is angled with respect to a workpiece surface such that the channels are at an angle with respect to the direction of wiping.

The method may be implemented such that a first channel is offset from a second channel.

The method may be implemented such that the wiping medium is a cloth free of raised portions.

The method may be implemented such that the wiping medium is removable.

The method may be implemented such that the wiping medium is a single-use wiping medium, comprising a connection mechanism for connecting to the fluid removal tool.

The method may be implemented such that the connection mechanism is a fastener.

The method may be implemented such that the connection mechanism is compliant.

The method may be implemented such that the connection mechanism comprises a hook and loop system.

The method may be implemented such that the fluid removal tool comprises a roll-to-roll system. The wiping medium is unrolled from a first roll and rolled onto a second roll.

The method may be implemented such that removing fluid from the workpiece includes unrolling a first portion of the wiping medium from a first roller and rolling a second portion of the wiping medium onto a second roller. The first portion has a first area, the second portion has a second area, and wherein the first and second areas are substantially similar.

The method may be implemented such that it includes removing debris from the second portion.

The method may be implemented such that removing fluid from the workpiece includes the fluid removal tool passively contacting the workpiece surface as the end-of-arm assembly transitions from a first state, comprising the first tool in contact with the workpiece, and a second state, comprising the second tool in contact with the workpiece.

The method may be implemented such that removing fluid from the workpiece includes the fluid removal tool semi-passively contacting the workpiece surface such that a motion controller coupled to the end-of-arm assembly extends the fluid removal tool into a workpiece contacting position as the end-of-arm assembly transitions from a first state, comprising the first tool in contact with the workpiece, and a second state, comprising the second tool in contact with the workpiece.

The method may be implemented such that the first tool is fastened to the end-of-arm robotic assembly.

The method may be implemented such that the workpiece is a vehicle.

The method may be implemented such that the vehicle is an automobile.

A fluid removal system mounted on a motive robot system is presented that includes a first roller mounted to the motive robot system, a second roller spaced apart from the first roller, a tension rod and a wiping material that is configured to be rolled off the first roller, over the tension rod, and rolled onto the second roller. The tension rod is positioned such that a portion of the wiping material contacting the tension rod, on a first side, contacts a workpiece on a second side.

The system may be implemented such that the wiping medium is a textile with a plurality of channels.

The system may be implemented such that the textile is a fabric.

The system may be implemented such that the wiping medium is angled with respect to a workpiece surface such that the channels are misaligned with a direction of wiping.

The system of may be implemented such that misaligned comprises the channels being at an angle with respect to the direction of wiping.

The system may be implemented such that a first channel is offset from a second channel.

The system may be implemented such that a first channel is staggered from a second channel.

The system may be implemented such that the wiping medium is a cloth free of raised portions.

The system may be implemented such that the wiping medium is free of distinct channels.

The system may be implemented such that the fluid removal system comprises a motion controller.

The system may be implemented such that the motion controller moves the tension rod.

The system may be implemented such that the motion controller controls tilt, pitch and yaw of the tension rod.

A motive robotic repair system is presented that includes a force control unit mounted to the motive robotic repair system, a first tool coupled to a first end effector. The first tool is configured to contact a worksurface. The first tool is an abrasive tool. The system also includes a fluid removal system comprising a wiping material and a reconditioning tool that removes some of the fluid or dried debris from the wiping material. The fluid removal tool is configured to remove fluid or debris from an area of the worksurface, and the fluid removal system is mounted to the motive robotic repair system.

The system may be implemented such that the fluid removal system comprises a fluid removal tool that contacts the worksurface.

The system may be implemented such that the fluid removal system comprises an air delivery device that provides air to the area.

The system may be implemented such that the removal system comprises a vacuum that sucks fluid from the area.

The system may be implemented such that the fluid removal tool comprises the wiping material.

The system may be implemented such that the fluid removal system comprises an absorbent wiping textile.

The system may be implemented such that the absorbent wiping textile is a woven fabric or a nonwoven fabric.

The system may be implemented such that the fluid removal system comprises a roll-to-roll system.

The system may be implemented such that the roll-to-roll system includes a first roller and a second roller. A first portion of the wiping medium is unrolled from a first roll and rolled onto a second roll.

The system may be implemented such that the wiping medium is indexed after each use, such that a first portion of the wiping medium is unrolled from the first rolled and a second portion is rolled onto the second roll, and wherein the first portion has a first area, the second portion has a second area, and the first and second areas are substantially similar in size.

The system may be implemented such that the wiping medium comprises a belt.

The system may be implemented such that it includes a fluid dispenser that dispenses fluid onto the area.

The system may be implemented such that it includes a second tool coupled to a second end effector. The second tool is configured to contact the worksurface.

The system may be implemented such that the first tool is a sanding tool, the second tool is a polishing tool. The fluid removal system is configured to remove fluid after the first tool contacts the area and before the second tool contacts the area.

The system may be implemented such that the first end effector is coupled to the force control unit.

The system may be implemented such that the second end effector is coupled to the force control unit.

The system may be implemented such that the fluid removal tool is coupled to the force control unit.

The system may be implemented such that the area comprises a defect, and wherein the robotic repair system is configured to repair the defect.

The system may be implemented such that the first tool is a sanding tool that sands the defect.

The system may be implemented such that the first tool is a polishing tool that polishes the area.

1. A wiping system for a robotic repair unit comprising:
a motive robot arm with a motor;
a connection mechanism coupled to the motive robot arm;
a wiping medium coupled to the connection mechanism, wherein the wiping medium comprises:
a base layer; and
a plurality of features extending from the base layer;
wherein the motive robot arm, powered by the motor, moves the wiping medium; and
wherein the motive robot arm is configured to move the wiping medium toward, or away from, a worksurface and wherein the motive arm is configured to press the wiping medium toward the worksurface during a wiping operation and wherein, during the wiping operation, the wiping medium is driven by a wiping motor against the surface.

2. The system of claim 1, wherein each of the plurality of features has a feature height and a feature thickness, and wherein the feature height is greater than a thickness of the base layer.

3. (canceled)

4. The system of claim 1, wherein the wiping motor moves the wiping medium in an oscillating or vibratory movement pattern.

5. The system of claim 1, wherein the wiping motor is separate from the motor.

6. The system of claim 1, wherein the wiping motor drives the wiping medium at a first speed during the wiping operation and spins the wiping medium at a second speed when the wiping medium is moving away from, or toward, the worksurface.

7. The system of claim 6, wherein the second speed is higher than the first speed.

8. (canceled)

9. (canceled)

10. The system of claim 6, wherein the wiping motor moves the wiping medium in a rotary motion pattern.

11. (canceled)

12. (canceled)

13. The system of claim 1, wherein the wiping medium removes 75% of a slurry after 50 sanding operations.

14-18. (canceled)

19. A robotic paint repair system comprising:
a force control unit;
a first tool system comprising a first end effector coupled to a first tool configured to contact a workpiece;
a second tool system comprising a second end effector coupled to a second tool configured to contact the workpiece;
a fluid removal tool comprising a wiping medium, the fluid removal tool being coupled to a motive robot arm, wherein the fluid removal tool is configured to remove fluid from the workpiece; and
wherein in a first state, the first tool is in position to contact and prepare the object surface and, in a second state, the second tool in position to contact and prepare the workpiece, in a third state, the fluid removal tool is in position to contact the workpiece;
wherein the motive robot arm is configured to move the wiping medium toward, or away from, a worksurface and wherein the motive arm is configured to press the wiping medium toward the worksurface during a wiping operation and wherein, during the wiping operation, the wiping medium is driven by a wiping motor against the surface.

20. (canceled)

21. The system of claim 19, wherein the first tool and the fluid removal tool are mounted to a single robotic repair unit.

22-28. (canceled)

29. The system of claim 19, wherein the wiping motor drives the wiping medium at a first speed during the wiping operation and spins the wiping medium at a second speed when the wiping medium is moving away from, or toward, the worksurface, wherein the second speed is higher than the first speed.

30-33. (canceled)

34. The system of claim 19, wherein the fluid removal tool is fastened to the end effector system using a compliant fastener.

35-38. (canceled)

39. The system of claim 19, wherein the fluid removal tool comprises a roll-to-roll system, wherein the wiping medium is unrolled from a first roller and rolled onto a second roller.

40-42. (canceled)

43. The system of claim 19, wherein the fluid removal tool applies a force against the wiping medium when the wiping medium is driven against the surface, and wherein the wiping medium moves laterally across the surface, and wherein the force and a lateral speed are sufficient to cause the wiping medium to near steady state operation of water uptake during a wiping cycle.

44-48. (canceled)

49. A method of repairing a workpiece, the method comprising:
contacting the workpiece using a first tool, wherein the first tool is attached to a first end effector aligned to process the workpiece surface, wherein the first end effector is coupled to a first force control unit mounted to an end-of-arm portion of a robotic repair unit, wherein the first tool is an abrasive tool;
removing fluid from the workpiece, using a fluid removal tool coupled to the robotic repair unit, wherein the fluid removal tool is a wiping medium, and wherein the wiping medium comprises an absorbent material; and
contacting the workpiece using a second tool, wherein the second tool is a second abrasive tool.

50-52. (canceled)

53. The method of claim 49, wherein the first and second tools are both mounted to the end-of-arm portion of the robotic repair unit, and wherein the first and second tools are mounted at least 90 degrees apart.

54-58. (canceled)

59. The method of claim 49, wherein the wiping medium is a single-use wiping medium, comprising a connection mechanism for connecting to the fluid removal tool.

60-62. (canceled)

63. The method of any of claim 49, wherein the fluid removal tool comprises a roll-to-roll system, wherein the wiping medium is unrolled from a first roll and rolled onto a second roll, and wherein removing fluid from the workpiece comprises:
unrolling a first portion of the wiping medium from a first roller;
rolling a second portion of the wiping medium onto a second roller; and
wherein the first portion has a first area, the second portion has a second area, and wherein the first and second areas are substantially similar.

64-67. (canceled)

68. The method of claim 49, wherein removing comprises contacting the wiping material to the workpiece surface, and wherein a force is applied to the wiping material, and the wiping material is moved laterally or rotationally against the workpiece surface at a speed, and wherein the force and the speed are sufficient to cause the wiping medium to operate near a steady state with respect to water uptake during a wiping cycle.

69. The method of claim 68, wherein the wiping material is moved at a lateral speed and a rotational speed and wherein the force, the lateral speed and the rotational speed are sufficient to cause the wiping medium to operate near the steady state.

70-93. (canceled)
